(19) United States
(12) Patent Application Publication
(10) Pub. No.: US 2018/0363841 A1
(43) Pub. Date: Dec. 20, 2018

(54) FIXING DEVICE FOR MOBILE TERMINAL AND UNMANNED AERIAL VEHICLE REMOTE

(71) Applicant: AUTEL ROBOTICS CO., LTD., Shenzhen (CN)

(72) Inventors: Longxue QIU, Shenzhen (CN); Zhiying LIANG, Shenzhen (CN); Jiakun WANG, Shenzhe (CN); Zengfei WANG, Shenzhen (CN)

(21) Appl. No.: 16/122,440

(22) Filed: Sep. 5, 2018

Related U.S. Application Data
(63) Continuation of application No. PCT/CN2016/092702, filed on Aug. 1, 2016.

(30) Foreign Application Priority Data
Mar. 7, 2016 (CN) 201620173254.8

(51) Int. Cl. F16M 13/02; F16B 2/12; F16H 19/04

(52) U.S. Cl. CPC F16M 13/02; B64C 39/024; F16H 19/04; F16B 2/12

(57) ABSTRACT

The present application relates to the field of mounting fixture technologies and provides a fixing device for a mobile terminal and an unmanned aerial vehicle remote. The fixing device includes: a base, the base having an accommodation space; a pair of clamping portions, movably disposed at two ends of the base; a pair of expansion links, one end of each expansion link being fixedly connected to the clamping portion on the same side, the other end movably mounted in the accommodation space of the base, and the clamping portion, the expansion link and the base jointly forming a space for accommodating a mobile terminal. The present application is convenient for fixing the mobile terminal and the mobile terminal does not easily drop after being fixed.

### CROSS-REFERENCE

This application is a continuation application of International Application No. PCT/CN2016/092702, filed on 1 Aug. 2016, which claims priority to Chinese Patent Application No. 201620173254.8, filed with the Chinese Patent Office on 7 Mar. 2016, which is incorporated herein by reference in its entirety.

### BACKGROUND

### Technical Field

The present application relates to the field of mounting fixture technologies, and in particular, to a fixing device for a mobile terminal and an unmanned aerial vehicle remote.

### Related Art

A mobile terminal is usually fixed by using a mounting fixture. A clamp on the mounting fixture is used to clamp the mobile terminal.

The existing clamp for clamping a mobile terminal fixes the mobile terminal in a single direction, making it inconvenient to assemble and disassemble the mobile terminal. Second, the existing clamp is controlled by pressing a switch to push out one end of the clamp (by resilience of a spring). Then a telescopic handle is pressed by hand to control the mobile terminal on the clamp. If the switch is touched during use, the mobile terminal easily drops from the clamp.

In view of this, it urgently needs to develop a fixing device that is convenient for fixing a mobile terminal and the mobile terminal does not easily drop after being fixed.

### SUMMARY

Embodiments of the present application mainly resolve a technical problem of providing a fixing device that is convenient for fixing a mobile terminal and the mobile terminal does not easily drop after being fixed.

To resolve the foregoing technical problem, technical solutions adopted in the embodiments of the present application are as follows:

A fixing device for a mobile terminal is provided. The fixing device includes:

a base, the base having an accommodation space;

a pair of clamping portions, movably disposed at two ends of the base;

a pair of expansion links, one end of each expansion link being fixedly connected to the clamping portion on the same side, the other end of each expansion link being movably mounted in the accommodation space of the base, wherein the clamping portion, the expansion link and the base jointly forming a space for accommodating a mobile terminal.

Preferably, the fixing device comprises a pair of elastic components, disposed in the accommodation space of the base, one end of each elastic component being fixedly connected to the expansion link on the same side, and the other end of each elastic component being fixed to the base.

Preferably, the fixing device comprises a gear, fixed to the base and disposed in the accommodation space of the base, two sides of the gear being engaged with the pair of expansion links respectively in a direction in which the expansion link moves along the base.

As the clamping portion of one side is stretched toward an outer side along the base by an external force and drives the expansion link to move toward the outer side along the base, the engagement of the expansion link with the gear drives the gear to rotate, the rotation of the gear drives the expansion link engaged with the other side of the gear to move toward the other outer side of the base and drives the other clamping portion to extend toward the other outer side along the base, so that the fixing device is in a stretched state and is used for accommodating a mobile terminal, and the elastic components are both in the stretched state as the clamping portion moves, and when the clamping portion is no longer subject to any external force, resilience of the elastic component drives the clamping portion and the expansion link to move toward the inner side of the base to clamp the mobile terminal.

Preferably, a gear rack is disposed in a direction in which the expansion link moves along the base, the gear rack being in engaged transmission with the gear.

Preferably, the clamping portion includes:

a connecting piece connected to the expansion link;

a blocking member having one side vertically connected to the connecting piece, the blocking member being attached to upper and lower ends of the mobile terminal; and

a limiting member vertically connected to the other side of the blocking member, the limiting member being attached to a screen side of the mobile terminal.

Preferably, the elastic component is a tension spring, a steel plate spring, a torsion bar spring, a gas spring or a rubber spring.

Preferably, the expansion link is provided with a positioning rod, one end of each elastic component is fixedly connected to the positioning rod on the expansion link on the same side, and a height of the positioning rod is consistent with a mounting height of the elastic component.

Preferably, the fixing device further includes a nut for fixing the gear to the base.

Preferably, the fixing device further includes a flexible cushion and a through hole, the flexible cushion being disposed on an inner surface of the clamping portion in contact with the mobile terminal, and the through hole penetrating a part of the clamping portion in contact with two ends of the mobile terminal.

Preferably, two ends of the base are each provided with an opening through which the expansion link is movably mounted, a width of the opening matching a width of a part of the expansion link connected to the clamping portion.

The embodiments of the present application further provide an unmanned aerial vehicle remote, the remote being provided with the foregoing fixing device for a mobile terminal.

Preferably, a mounting bracket protrudes from the unmanned aerial vehicle remote, the base of the fixing device for a mobile terminal being fixed to the mounting bracket.

The embodiments of the present application have the following beneficial effects. In the embodiments of the present application, the fixing device has two clamping portions. When the fixing devices is pulled, the clamping portions on both sides can be opened, which can facilitates the fixation of a mobile terminal of various sizes, so that the mobile terminal is fixed in an easier and more labor-saving manner.

### BRIEF DESCRIPTION OF THE DRAWINGS

FIG. 1 is an exploded schematic structural diagram of a fixing device for a mobile terminal according to an embodiment of the present application;

FIG. 2 is a schematic structural diagram of a fixing device for a mobile terminal when contracted according to an embodiment of the present application;

FIG. 3 is a schematic structural diagram of a fixing device for a mobile terminal when opened according to an embodiment of the present application; and

FIG. 4 is a schematic structural diagram of an unmanned aerial vehicle remote according to an embodiment of the present application.

### DESCRIPTION OF REFERENCE NUMERALS

| | |
|---|---|
| Fixing device | 10 |
| Base | 11 |
| Accommodation space | 111 |
| Clamping portion | 12 |
| Connecting piece | 121 |
| Blocking member | 122 |
| Limiting member | 123 |
| Expansion link | 13 |
| Positioning rod | 131 |
| Tension spring | 14 |
| Gear | 15 |
| Gear rack | 16 |
| Nut | 17 |
| Through hole | 18 |
| Unmanned aerial vehicle remote | 20 |

### DETAILED DESCRIPTION

To help to understand the present application, the following describes in more detail the present application with reference to the accompanying drawings and specific implementations. It should be noted that when an element is described as being “fixed” to another element, it can be directly on the another element, or one or more intermediate elements may exist therebetween. When an element is described as being “connected” to another element, it can be directly connected to the another element, or one or more intermediate elements may exist therebetween. Terms such as “vertical”, “horizontal”, “left”, “right” and similar expressions used in this specification are merely used for the purpose of description.

Unless otherwise defined, meanings of all technical and scientific terms used in the specification are the same as those usually understood by a person skilled in the technical field of the present application. The terms used in the specification of the present application are merely intended to describe the specific implementations rather than limit the present application. A term “and/or” used in this specification includes any or all combinations of one or more of the related listed items.

Moreover, it should be noted that a mobile terminal in this embodiment of the present application includes: a mobile phone, a tablet computer and another similar mobile terminal device. The following describes the embodiments of the present application by using a mobile phone as an example.

### Embodiment 1

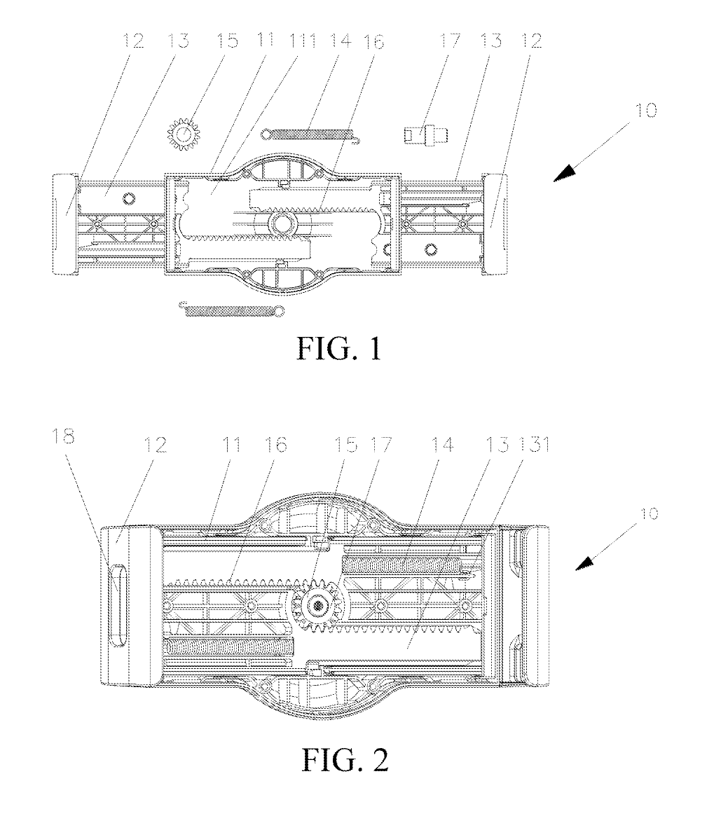

Referring to FIG. 1 to FIG. 3, this embodiment provides a fixing device 10 for a mobile terminal. The fixing device 10 includes a base 11, a pair of clamping portions 12, a pair of expansion links 13, a pair of elastic components 14 and a gear 15. The base 11 has an accommodation space 111. The clamping portions 12 are movably disposed at two ends of the base 11. One end of each expansion link 13 is fixedly connected to the clamping portion 12, and the other end is movably mounted in the accommodation space 111 of the base 11. The clamping portion 12, the expansion link 13 and the base 11 jointly form a space for accommodating a mobile terminal. The elastic components are disposed in the accommodation space 111 of the base 11. One end of each elastic component is fixedly connected to the expansion link 13 on the same side, and the other end is fixed to the base 11. The gear 15 is fixed to the base 11 and disposed in the accommodation space 111 of the base 11. Two sides of the gear 15 engage with the pair of expansion links 13 respectively in a direction in which the expansion link 13 moves along the base 11.

The two ends of the base 11 are each provided with an opening (not shown) through which the expansion link 13 is movably mounted. A width of the opening matches a width of a part of the expansion link 13 connected to the clamping portion 12, so that the expansion link 13 is not easily loosened in a direction perpendicular to a movement direction (an up-and-down direction in the figure) when moving inside the base 11. Therefore, a user feels better when operating it.

Specifically, the gear 15 is connected to the expansion link 13 by means of engagement of the gear 15 with the gear rack 16. A gear rack 16 is disposed in a direction in which the expansion link 13 moves along the base 11. The gear rack 16 is in engaged transmission with the gear 15. The transmission manner between the gear 15 and the gear rack 16 is stable and reliable, having a long service life. In addition, the gear 15 is fixed to the base 11 by using a nut 17. Fixing the gear 15 to the nut 17 is intended to prevent the gear 15 from moving during the rotation of the gear 15. Therefore, the nut 17 is used to limit the gear 15.

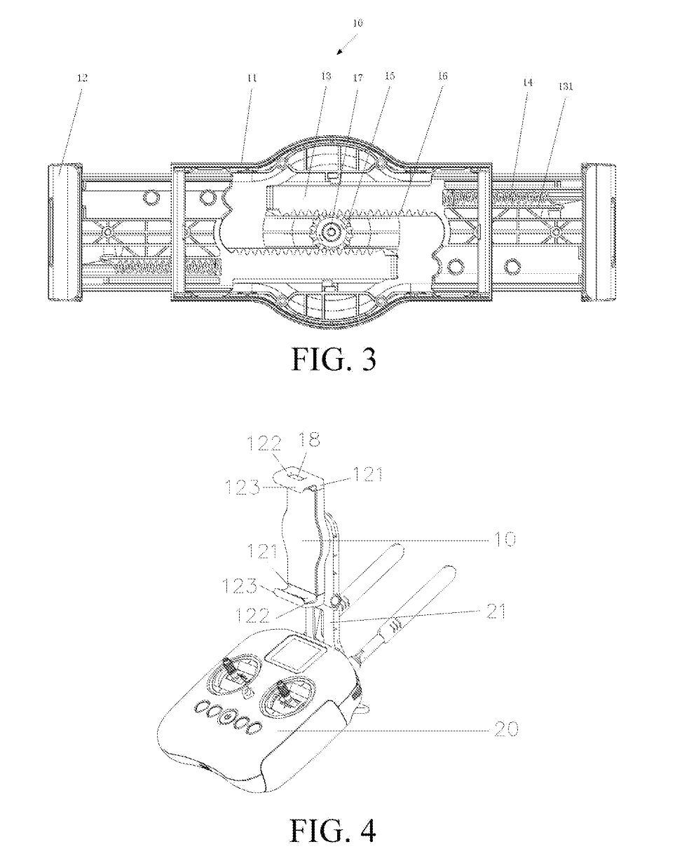

Also referring to FIG. 4, the clamping portion 12 further includes a connecting piece 121, a blocking member 122 and a limiting member 123. The connecting piece 121 is connected to the expansion link 13. One side of the blocking member 122 is vertically connected to the connecting piece 121 and attached to upper and lower ends of the mobile terminal, to prevent the mobile phone from being detached from the two ends of the fixing device 10. The other end of the blocking member 122 is vertically connected to the limiting member 123. The limiting member 123 is attached to a screen side of the mobile terminal, to prevent the mobile phone from being detached from the fixing device 10 from the screen side.

Each expansion link 13 is provided with a positioning rod 131. One end of each elastic component is fixedly connected to the positioning rod 131 on the expansion link 13 on the same side. The tension spring 14 is fixed to the positioning rod 131, so that the tension spring 14 is fixed to the expansion link 13. When moving, the expansion link 13 pulls one end of the tension spring 14 to extend. A height of the positioning rod 131 is consistent with a mounting height of the elastic component, so that during fixing of the mobile terminal, the tension spring 14 can be maintained stable during use. In this way, the clamped mobile terminal cannot be moved arbitrarily and use of the mobile terminal by the user is not affected. The elastic component may be a tension spring 14, a steel plate spring, a torsion bar spring, a gas spring or a rubber spring, which may be the tension spring 14 in this embodiment. The tension spring 14 is relatively easy to pull and the elastic force is even.

Further, the fixing device 10 further includes a flexible cushion and a through hole 18. The flexible cushion is disposed on an inner surface of the clamping portion 12 in contact with the mobile terminal. The through hole 18 penetrates a part of the clamping portion 12 in contact with two ends of the mobile terminal. The flexible cushion functions to cushion and protect the mobile terminal. When the mobile terminal is fixed to the fixing device 10, because the clamping portion 12 is a metal mold, during clamping of the mobile terminal, it is possible that the clamping force is excessive, causing damage to two end portions of the mobile terminal. After the flexible cushion is added, the problem that the clamping portion 12 causes damage to the two end portions of the mobile terminal is resolved. The design of the through hole 18 helps the user pull the clamping portion 12 to complete the operation of fixing the mobile terminal and facilitates exposure of various interfaces and audio output ports of the mobile terminal, which is convenient for the user to use.

In the fixing device 10 for a mobile terminal of this embodiment of the present application, the base 11 mainly carries the mobile terminal and the expansion link 13 itself can be freely stretched and contracted. When the clamping portion 12 of one side is manually pulled, the clamping portion 12 of the side is stretched toward an outer side along the base 11 by an external force and drives the expansion link 13 to move toward the outer side along the base 11. The engagement of the expansion link 13 with the gear 15 drives the gear 15 to rotate. The rotation of the gear 15 drives the expansion link 13 engaged with the other side of the gear 15 to move toward the other outer side of the base 11 and drives the other clamping portion 12 to extend toward the other outer side along the base 11, so that fixing device 10 is in a stretched state and is used for accommodating a mobile terminal. In this case, the elastic components are both in the stretched state as the clamping portion 12 moves. When the clamping portion 12 is no longer subject to any external force, resilience of the elastic component drives the clamping portion 12 and the expansion link 13 to move toward the inner side of the base 11 to clamp the mobile terminal. In this case, the fixing device 10 is in a contracted state. After the mobile terminal is tested or used by a user, the clamping portion 12 is manually pulled to take out the mobile terminal.

In this embodiment of the present application, the gear 15 is in engaged transmission with the expansion links 13 on the two sides. When the clamping portion 12 and the expansion link 13 on a single side move, the gear 15 can indirectly drive the clamping portion 12 and the expansion link 13 on the other side to move. In this way, the clamping portions 12 on both sides can be opened when the clamping portion 12 on the single side is pulled, so that the mobile terminal is fixed in an easier and more labor-saving manner. The elastic component is disposed to control a stretching length of the clamping portion 12, so that the clamping portion 12 is not arbitrarily pulled out. After an external force applied to the clamping portion 12 is removed, the resilience of the elastic component can be used to tightly clamp the mobile terminal, so that the mobile terminal does not easily drop after being fixed, thereby improving stability of the mobile terminal placed on the fixing device 10.

In this embodiment, there are two clamping portions 12, two expansion links 13, two tension springs 14 and two positioning rods 131. A two-way fixed manner is adopted. The clamping portions 12 move in two directions. Different from a one-way movement of an existing clamp, the clamping portions 12 moving in two directions are more convenient to use. In addition, the transmission design of the gear 15 needs only to manually pull the clamping portion 12 on one end and the clamping portion 12 on the other end also moves toward an opposite direction at the same time, so that the entire fixing device 10 is in the stretched state. Then the mobile terminal is placed on the base 11. Finally, the clamping portion 12 clamps the mobile terminal to fix it. Since the fixing device in the embodiments of the present application has two clamping portions, when the fixing devices is pulled, the clamping portions on both sides can be opened, which can facilitates the fixation of a mobile terminal of various sizes, so that the mobile terminal is fixed in an easier and more labor-saving manner.

The fixing device 10 for a mobile terminal provided in this embodiment is applicable to various scenarios, such as an unmanned aerial vehicle remote, a car phone holder, a desktop phone holder and the like.

### Embodiment 2

Referring to FIG. 4, this embodiment of the present application further provides an unmanned aerial vehicle remote 20. The remote is provided with the fixing device 10 for a mobile terminal in Embodiment 1. Specifically, a mounting bracket 21 protrudes from the unmanned aerial vehicle remote 20. The base 11 of the fixing device 10 for a mobile terminal is fixed to the mounting bracket 21. There are multiple fixing manners. The base 11 may be fixed by using screws, or by disposing a suction cup, or by disposing a buckle, or the like. This is not limited in the present application.

When a user operates the unmanned aerial vehicle remote 20, the user can directly receive and view, by using a mobile terminal while operating, content shot by the unmanned aerial vehicle, which is simple and convenient to use.

It should be noted that preferred implementations of the present application are given in the specification of the present application and the accompanying drawings thereof. However, the present application can be implemented in many different forms, and is not limited to the implementations described in the specification. These implementations are not intended to limit the content of the present application. The implementations are provided to make understanding of the disclosed content of the present application more thorough and comprehensive. In addition, the foregoing technical features are further combined with each other to form various implementations that are not listed above and are all considered to be within the scope of the specification of the present application. Further, a person of ordinary skill in the art can make improvements or modifications according to the foregoing descriptions. All such improvements and modifications shall fall within the protection scope of the appended claims of the present application.

What is claimed is:

1. A fixing device for a mobile terminal, the fixing device comprising:
a base, the base having an accommodation space;
a pair of clamping portions, movably disposed at two ends of the base;
a pair of expansion links, one end of each expansion link being fixedly connected to the clamping portion on the same side, and the other end of each expansion link being movably mounted in the accommodation space of the base, wherein the clamping portion, the expansion link and the base jointly form a space for accommodating a mobile terminal.

2. The fixing device for a mobile terminal according to claim 1, wherein the fixing device further comprises a pair of elastic components, disposed in the accommodation space of the base, one end of each elastic component being fixedly connected to the expansion link on the same side, and the other end of each elastic component being fixed to the base.

3. The fixing device for a mobile terminal according to claim 2, wherein the fixing device further comprises a gear, fixed to the base and disposed in the accommodation space of the base, two sides of the gear being engaged with the pair of expansion links respectively in a direction in which the expansion link moves along the base, wherein
as the clamping portion of one side is stretched toward an outer side along the base by an external force and drives the expansion link to move toward the outer side along the base, the engagement of the expansion link with the gear drives the gear to rotate, and the rotation of the gear drives the expansion link engaged with the other side of the gear to move toward the other outer side of the base and drives the other clamping portion to extend toward the other outer side along the base, so that the fixing device is in a stretched state and is used for accommodating a mobile terminal, and the elastic components are both in the stretched state as the clamping portion moves, and when the clamping portion is no longer subject to any external force, resilience of the elastic component drives the clamping portion and the expansion link to move toward the inner side of the base to clamp the mobile terminal.

4. The fixing device for a mobile terminal according to claim 3, wherein a gear rack is disposed in a direction in which the expansion link moves along the base, the gear rack being in engaged transmission with the gear.

5. The fixing device for a mobile terminal according to claim 1, wherein the clamping portion comprises:
a connecting piece connected to the expansion link;
a blocking member having one side vertically connected to the connecting piece, the blocking member being attached to upper and lower ends of the mobile terminal; and
a limiting member vertically connected to the other side of the blocking member, the limiting member being attached to a screen side of the mobile terminal.

6. The fixing device for a mobile terminal according to claim 2, wherein the elastic component is a tension spring, a steel plate spring, a torsion bar spring, a gas spring or a rubber spring.

7. The fixing device for a mobile terminal according to claim 2, wherein the expansion link is provided with a positioning rod, one end of each elastic component is fixedly connected to the positioning rod on the expansion link on the same side, and a height of the positioning rod is consistent with a mounting height of the elastic component.

8. The fixing device for a mobile terminal according to claim 3, wherein the fixing device further comprises a nut for fixing the gear to the base.

9. The fixing device for a mobile terminal according to claim 1, wherein the fixing device further comprises a flexible cushion and a through hole, the flexible cushion being disposed on an inner surface of the clamping portion in contact with the mobile terminal, and the through hole penetrating a part of the clamping portion in contact with two ends of the mobile terminal.

10. The fixing device for a mobile terminal according to claim 1, wherein two ends of the base are each provided with an opening through which the expansion link is movably mounted, a width of the opening matching a width of a part of the expansion link connected to the clamping portion.

11. An unmanned aerial vehicle remote, the remote being provided with the fixing device for a mobile terminal according to claim 1.

12. The unmanned aerial vehicle remote according to claim 11, wherein a mounting bracket protrudes from the unmanned aerial vehicle remote, the base of the fixing device for a mobile terminal being fixed to the mounting bracket.
